(19) United States
(12) Patent Application Publication
(10) Pub. No.: US 2025/0229511 A1
(43) Pub. Date: Jul. 17, 2025

(54) FILM AND METHOD FOR INSTALLING FILM FOR POLYCARBONATE AND ACRYLIC SUBSTRATES

(71) Applicant: Shine Detailing, LLC., Glenwood Springs, CO (US)

(72) Inventor: Charlie Steinberg, Glenwood Springs, CO (US)

(21) Appl. No.: 19/014,851

(22) Filed: Jan. 9, 2025

Related U.S. Application Data
(60) Provisional application No. 63/620,636, filed on Jan. 12, 2024.

(51) Int. Cl. B32B 27/08; B32B 1/00; B32B 7/12; B32B 27/30; B32B 27/36; B32B 27/40; B32B 38/00; B32B 38/16

(52) U.S. Cl. CPC B32B 27/08; B32B 1/00; B32B 7/12; B32B 27/308; B32B 27/365; B32B 27/40; B32B 38/0004; B32B 38/0012; B32B 38/162; B32B 38/164; B32B 2038/0016; B32B 2038/0056; B32B 2038/168; B32B 2250/02; B32B 2250/24; B32B 2255/10; B32B 2255/20; B32B 2307/536; B32B 2315/02; B32B 2333/08; B32B 2369/00; B32B 2375/00

(57) ABSTRACT

A proposed film (e.g., clear film, protective film, urethane film, polyurethane film, thermoplastic urethane film, ceramic film, or a combination of two or more films, or the like) and method of installing the proposed film will enhance and protect any polycarbonate or acrylic surfaces. The proposed film and proposed method for installing the proposed film is designed to solve the issues inherent in the soft polycarbonate and acrylic materials or substrate. For example, polycarbonate and acrylic substrates with a hardness level of 3-4 do not have the same scratch resistance or self-healing properties as the proposed film's 9 hardness level. By applying the proposed film to existing polycarbonate or acrylic, we get all the benefits of the proposed film, enhancing the substrate to which it is applied.

### CROSS-REFERENCE TO RELATED APPLICATIONS

This application is a non-provisional of U.S. Patent Application No. 63/620,636 filed Jan. 12, 2024, the disclosure of which is incorporated herein by reference in its entirety and for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to a film for use with polycarbonate materials and acrylic materials.

### BACKGROUND

Polycarbonate and acrylics are soft materials as defined by the Mohs Hardness Scale. Acrylics are a 3 on the hardness scale. Polycarbonates range between 3 and 4 on the hardness scale. Because polycarbonates and acrylics are soft materials, polycarbonates and acrylics are very easily scratched, distorted, stained, and discolored. These defects are not easy to clean or correct. Further, manufactures of acrylics and polycarbonate windows include warnings that warn against the use of razor blades, scrapers, squeegees, or brushes to avoid damaging the surface of the polycarbonate and acrylic windows.

Hence, there is a need to have a film installation method for polycarbonate or acrylic materials that does not damage a surface of the polycarbonate or acrylic materials.

### SUMMARY

The proposed film (e.g., clear film, protective film, urethane film, polyurethane film, thermoplastic urethane film, ceramic film, or a combination of two or more films, or the like) and method of installing the proposed film will enhance and protect any polycarbonate or acrylic surfaces. The proposed film and proposed method for installing the proposed film is designed to solve the issues inherent in the soft polycarbonate and acrylic materials or substrate. For example, polycarbonate and acrylic substrates with a hardness level of between 3 and 4 do not have the same scratch resistance or self-healing properties as the proposed film's 9 hardness level. By applying the proposed film to existing polycarbonate or acrylic surfaces, the polycarbonate or acrylic surfaces benefit from the film's hardness level and are harder to scratch or damage. Additionally, the film's hydrophobic properties, scratch resistance, 100% UV protection, self-healing, and self-adhering properties keep the polycarbonate or acrylic surfaces looking new and make them easy to clean. The chemical resistance or corrosion resistance and anti-oxidation properties of the proposed film and application require no polishing of the surface of the substrate and provide for very low maintenance. Thus, time and money can be saved by applying the proposed film to polycarbonate and acrylic materials or substrates to protect the polycarbonate and acrylic materials or substrates from damage.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a view of layers of a film capable of being coupled to a substrate;

FIGS. 2A-2C are perspective views of a film being coupled to a substrate which is a gondola window;

FIGS. 3A-3F are views of different ways that a film can be coupled to a substrate;

FIGS. 4A and 4B show a film installed on a gondola; and

FIG. 5 is a method for installing a film on a substrate.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” “attached,’ and “coupled” and variations thereof are used broadly and encompass both direct and indirect mountings, connections, supports, and couplings. Further, “connected” and “coupled” are not restricted to physical or mechanical connections or couplings. In this application, the use of the singular includes the plural unless specifically stated otherwise, and use of the terms “and” and “or” means “and/or” unless otherwise indicated.

As used herein, unless otherwise defined or limited, directional terms are used for convenience of reference for discussion of particular figures or examples. For example, references to downward, upward, or other directions or top, bottom, middle, or other positions may be used to discuss aspects of a particular example or figure, but do not necessarily require similar orientation or geometry in all installations or configurations. Further, the terms “first,” “second,” “third,” “fourth,” or the like are not limited to any particular order or a particular number of items. The terms “first,” “second,” “third,” “fourth,” are intended to merely distinguish between different elements or components unless otherwise specified. Additionally, unless otherwise specified or limited, the terms “about” and “approximately,” as used herein with respect to a reference value or ratio, refer to variations from the reference value or ratio of ±20% or less (e.g., ±15, ±10%, ±5%, etc.), inclusive of the endpoints of the range.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some of the discussion below describes that the proposed film can be coupled to a window of a gondola. The context and particulars of this discussion are presented as examples only. For example, embodiments of the disclosed invention can be configured in various ways, including with other shapes and arrangements of elements that are expressly described or illustrated. Similarly, embodiments of the invention can be used with arrangements of gondolas, ski lifts, etc. other than those expressly illustrated or described herein. In some cases, the film could be applied to polycarbonate surfaces or acrylic surfaces in the ski industry, amusement industry, aviation industry, or other industry, or the like.

Polycarbonate surfaces or acrylic surfaces such as windows of gondolas are vulnerable to scratches, distortions, stains, discolorations, etc. The more scratches, distortions, stains, discolorations, etc., the harder it is for a user to see outside of the window of the gondola. Hence, there is a need to protect the polycarbonate surfaces or acrylic surfaces from one or more scratches, distortions, stains, discolorations, etc.

Embodiments of the invention can address these or other issues. For example, in various cases, the proposed film can be applied to one or more polycarbonate surfaces or acrylic surfaces such as one or more windows of a gondola formed from polycarbonate or acrylic materials. The proposed film can be used to protect the one or more surfaces or windows from scratches, stains, graffiti, stickers, markers, paint, wear and tear, environmental conditions, UV fading, discoloration, oxidation, or erosion. In various cases, the film can be applied to one or more surfaces or windows of a gondola. In some cases, the proposed film can be applied to both a front surface and a back surface of the polycarbonate or acrylic surface to protect the surface from scratches, distortions, stains, and discolorations. By applying the film to both the front and the back of the surface, the surface can be protected from debris or other materials that can cause scratches, distortions, stains, and discolorations. For example, by applying the film to a front and back surface of a window the front surface and the back surface of the window can be protected from debris or other materials that can cause scratches, distortions, stains, and discolorations. Additionally, the surfaces are easier to clean on both the front and the back. The proposed film is at least partially clear or transparent to ensure users can see through the surface or window. The proposed film is self-healing, hydrophobic, and can include a clear film with 100% UV resistance. In some cases, the proposed film can be further be coated in a ceramic material.

In various cases, the proposed film can extend the life expectancy of a surface, a window, or other substrate by up to 5×. The proposed film can be applied to each side of the applicable window substrate, using a slip solution or install gel. Once cured the proposed film acts as a sacrificial layer to the substrate. The proposed film can be replaced quicker, easier, and cheaper in most cases than the window or substrate upon which the film is installed.

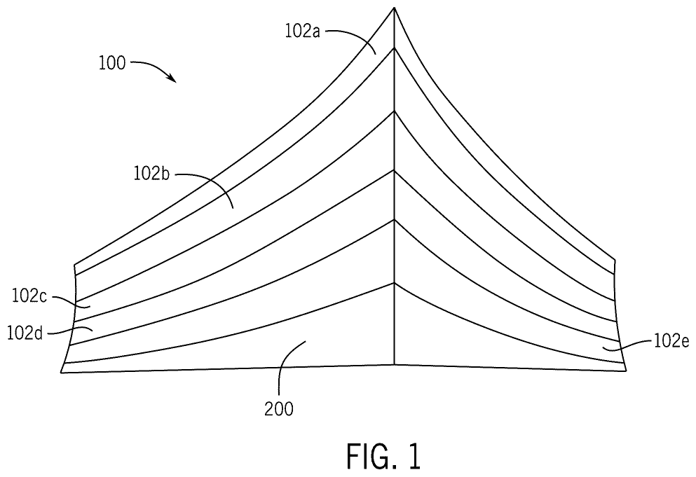

Turning to FIG. 1, the proposed film 100 can be formed from one or more layers 102a-102e (collectively, layers 102). The one or more layers 102 include one or more of a protection film layer 102a, a top coat layer 102b, a thermoplastic polyurethane (TPU) layer 102c, an adhesive layer 102d, and a release liner layer 102c.

The protection film layer 102a or cap sheet can be used to maintain the best finish of a top surface 104 of the film 100 through production and shipping. In other words, the protection film layer 102a protects the top surface 104 of the film 100 from damage during production and shipping of the film 100. The protection film layer 102a is removable once the film 100 has been applied to a substrate (e.g., a window of a gondola, a window or transparent surface of an amusement park ride, a window of an airplane, a polycarbonate surface, an acrylic surface, or the like). In various cases, the protection film layer 102a has a thickness of about 38 micrometers.

The top coat layer 102b includes the top surface 104 of the film 100. The top coat layer 102b can include a ceramic coating or the like and can have a thickness that is approximately 3 micrometers. In various cases, the top coat layer 102b can be self-healing. For example, when heat is applied to the top surface 104 of the film 100, the top coat layer 102b can be configured to expand and fix tears, scratches, chips, divots, or other imperfections on the top surface 104 of the film 100 or within the top coat layer 102b. At least the top surface 104 of the top coat layer 102b can be hydrophobic which allows the top surface 104 to be self-cleaning. In other words, the top surface 104 of the top coat layer 102b is configured to allow water or other liquid to simply run off or not stick to the top surface 104.

The TPU layer 102c can include, without limitation, one or more of urethane film, polyurethane film, thermoplastic urethane film, a thermoplastic polyurethane film, or the like. The TPU layer 102c has a thickness that is approximately 150 micrometers. The TPU layer 102c is a middle layer, a core layer, or an internal layer of the film 100 and can be configured to provide durability, strength, stretch to the film 100.

The adhesive layer 102d can include one or more of an adhesive, a glue, or other sticky material, or the like. The adhesive layer 102d can be approximately 30 micrometers and can include a bottom surface 106 of the film 100. The adhesive layer 102d can be used to couple the film 100 to a substrate using a first solution such as a slip solution or an install gel or a combination of the slip solution and the install gel. The adhesive layer 102d can be used to adhere the film to the substrate for a semi-permanent bond that keeps the film 100 in place on the substrate. However, the bond is semi-permanent and the film 100 is able to be removed from the substrate with the introduction of heat or steam and a careful removal process.

The release liner layer 102e can be formed from polyester material or the like and can have a thickness of about 75 micrometers. The release liner layer 102e protects the adhesive layer 102d during production and shipping. In other words, the release liner layer 102e protects the adhesive layer 102d from collecting debris such as dust, dirt, or the like or being damaged. The release liner layer 102e can be easily removed from the adhesive layer 102d when the film 100 is ready to be installed on the substrate.

In various cases, a total thickness the top coat layer 102b, the TPU layer 102c, and the adhesive layer 102d can be approximately 180±3 micrometers.

The proposed film 100 has the following properties and advantages. First, the film 100 is a scratch resistant paint protective film that can be coupled to a substrate, in particular at least a partially transparent substrate comprising polycarbonate material or acrylic material. Second, the film 100 has self-healing properties, for example, within the top coat layer 102b, that can repair tears, scratches, chips, divots, or other imperfections on the top surface 104 of the film 100. In a non-limiting example, when heat is applied to the film, the film can expand to fill or cover the tears, scratches, chips, divots, or other imperfections. In various cases, the top surface 104 or top coat layer 102b can be configured to expand and self-heal around approximately 100° Fahrenheit. The heat could be applied using a heat gun, water, steam, or some other heating method. Third, the film 100 can be optically clear with anti-yellowing properties. In various cases, the film had less than a 0.8 ΔE change in color when tested (Q-UV1.000 Hours). Fourth, the film 100 has increased gloss greater than approximately 96%) (60°). Fifth, the film 100 is able to maintain its transparency approximately greater than 96% (Haze meter). Sixth, the film 100 increases the insulation of the substrate by approximately greater than 1.878. Seventh, the top surface 104 of the film is hydrophobic and increases the hydrophobicity of the substrate by approximately greater than 98° (Water contact angle). Eighth, the film 100 is removable without damaging the substrate. Ninth, the film 100 can be used to enhance and protect the substrate even when the substrate is old, scratched, damaged or the like, making the substrate more transparent compared to the substrate without the film. In some cases, the film 100 can even be configured to fill one or more scratches on the substrate and reduce the appearance of the scratches.

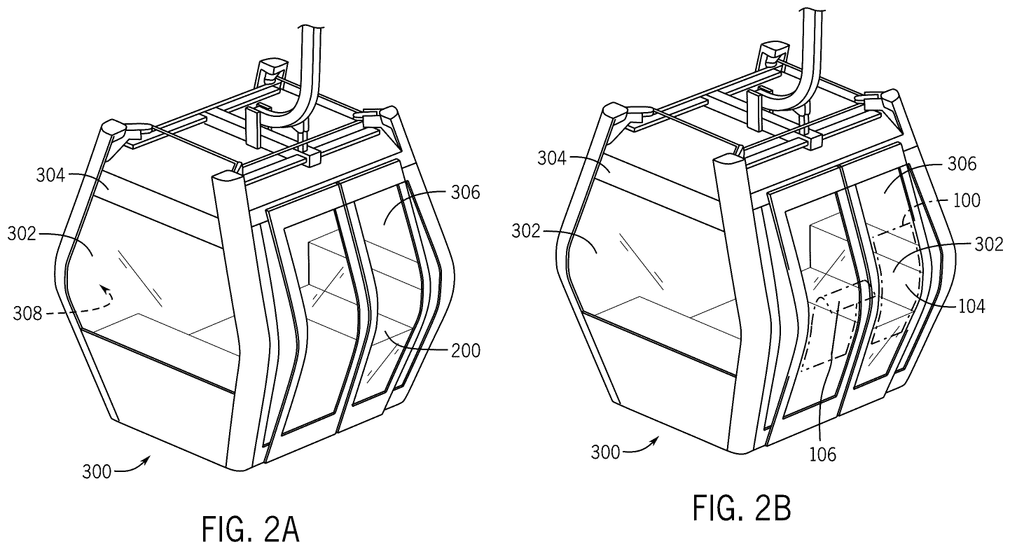

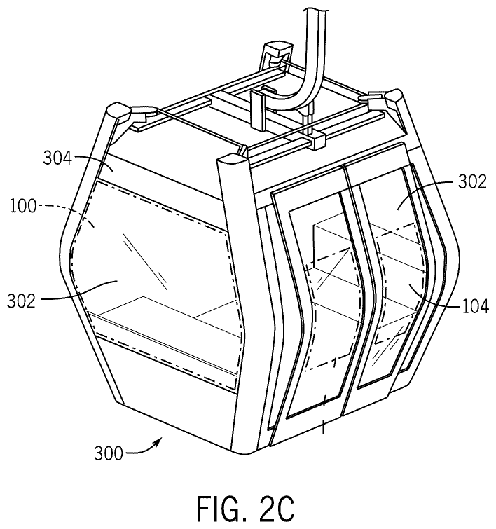

In various cases, as shown in FIGS. 2A-2C (collectively, FIG. 2), the film 100 can be installed on a substrate 200. In some cases, the substrate 200 could be located on a gondola 300 (as shown in FIG. 2), a plane, an amusement park ride, or the like. In various cases, the substrate 200 could be one or more of one or more windows 302 of the gondola 300, others surfaces 304 such as a door, a side, a top, a bottom, or the like of the gondola 300, one or more windows or other surfaces of a plane, one or more windows or other surfaces of an amusement park ride, or one or more polycarbonate surfaces, one or more acrylic surface, one or more other at least partially transparent or clear surfaces, or the like. In various cases, the substrate 200 could be at least partially transparent, substantially transparent, transparent, at least partially clear, substantially clear, clear, or the like. In other words, a user of the substrate 200 or a person viewing the substrate 200 can at least partially see through the substrate 200. In some instances, the substrate 200 further includes a polycarbonate material or acrylic material or is formed from a polycarbonate material or acrylic material.

In a non-limiting example, the window 302 of the gondola 300 could be formed from or comprise a polycarbonate material or an acrylic material and could be at least partially transparent or clear. In various cases, as shown in FIG. 2B, the film 100 can be applied to an outer surface 306 of the gondola window 302. In some instances, the film 100 could further be applied to an inner surface 308 of the gondola window 302 located inside the gondola 300. In other words, the film 100 can be applied to an outer surface 306 of the gondola window 302 located outside the gondola 300 and an inner surface 308 of the gondola window 302 opposite the outer surface 306 and located inside of the gondola 300. By applying the film 100 to one or more of the outer surface 306 or inner surface 308 of the gondola window 302, the soft polycarbonate or acrylic surfaces of the gondola window 302 can benefit from the hardness of the film 100 and be protected from wear and tear.

In order to install the film 100 on the window 302, a bottom surface 106 of the adhesive layer 102d can be applied to the outer surface 306 or inner surface 308 of the gondola window. In this scenario, when the film 100 is fully installed on the outer surface 306 of the window 302, as shown in FIG. 2C, the window 302 can maintain its transparency such that users of the gondola 300 or a person viewing the gondola window 302 can at least partially or fully see through the gondola window 302. Additionally, by applying the film 100 to both the outer surface 306 and the inner surface 308 of the gondola window, both the outer surface 306 and the inner surface 308 can be protected and the transparency of the window 302 can be maintained.

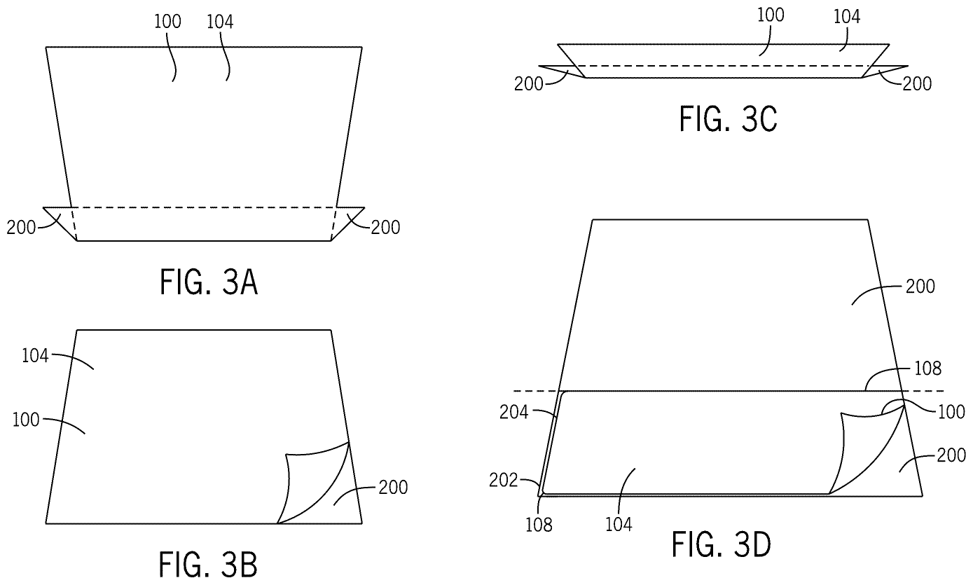

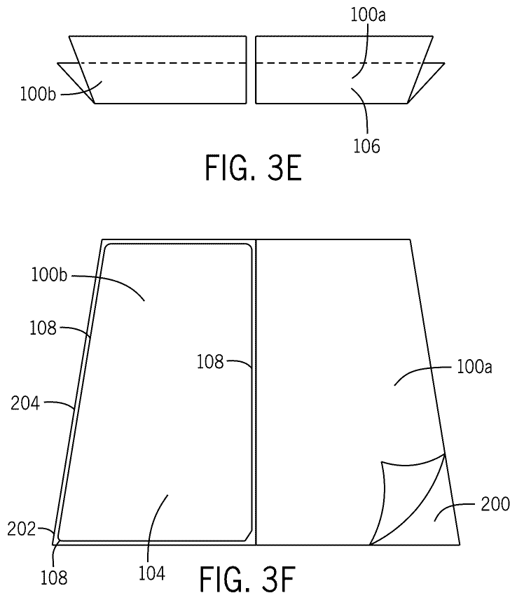

The film 100 can be installed on a substrate 200 in a variety of ways, as shown in FIGS. 3A-3F.

For example, the film 100 can be fully installed on the substrate 200, as shown in FIGS. 3A and 3B. This means that the film 100 is approximately a same size and approximately a same shape as the substrate 200. In other words, installers of the film 100 can cut the film 100 based on the size and the shape of the substrate and ensure that the film 100 is approximately a same size and approximately a same shape as the substrate 200. In this scenario, there are no seams 108. Alternatively, there may be some seams 108 that are visible at one or more corners 202 or edges 204 of the substrate 200 with no seams 108 that are visible in between the one or more corners 202 or edges 204 of the substrate 200. Examples of one or more seams 108 that are visible at one or more corners 202 or edges 204 of the substrate 200 can be seen in FIG. 3D and 3F.

Alternatively, the film 100 can be partially installed on substrate 200 at selected or target locations as shown in FIGS. 3C and 3D. By installing the film 100 only at selected or target locations of the substrate 200, costs for installing the film 100 can be reduced and only the parts of the substrate 200 that are most susceptible to damage can be protected with the film 100. There may be some seams 108 that are visible where the film 100 ends or at one or more corners 202 or edges 204 of the substrate 200.

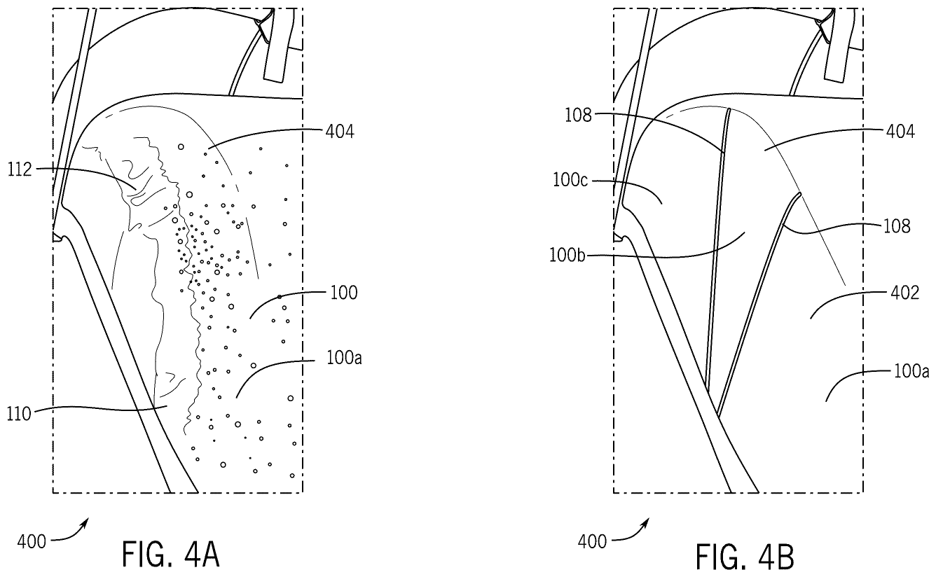

In yet other cases, the film 100 can be installed in one or more pieces or parts. In a non-limiting example, as shown in FIGS. 3E and 3F, the film 100 is installed on the substrate 200 as a first piece 100a and a second piece 100b. In some cases, there could be more than two pieces of film 100 depending on the substrate 200. There may be some seams 108 that are visible where the film 100 ends, where the first piece 100a meets the second piece 100b of the film 100, or at one or more corners 202 or edges 204 of the substrate 200. In various cases, dividing the film 100 into one or more pieces can help relieve stress on the film 100 especially when the substrate 200 has one or more curved surface or edges. This is discussed in more detail with respect to FIG. 4.

Turning to FIGS. 4A and 4B, FIGS. 4A and 4B show film 100 installed on a window 402 of a gondola 400. When installed on a curved surface 404 of the window 402 of the gondola 400 in one continuous piece, as shown in FIG. 4A, the film 100 can sometimes experience bubbling 112 towards one or more edges 110 of the film 100 or between one or more edges 110 of the film 100. This bubbling 112 results in a messy, unfinished look.

In order to solve the bubbling issue, the film 100 can be divided into two or more pieces 100a-100c. By dividing the film 100 into two or more pieces 100a-100c, stress on the film 100 can be relieved and the film 100 can be prevented from bubbling. There may be one or more seams 108 that are visible between the one or more pieces 100a-100c of film 100. In some cases, the one or more pieces 100a-100c can be cut such that, when the one or more pieces 100a-100c are placed together on the window 402, the one or more pieces 100a-100c, as a whole, are approximately a same size and a same shape as the window 402. In some cases, the curved surface 404 could be shaped or curve like a half circle or half oval and the film 100 can be cut into at least three pieces 100a-100c.

A person of ordinary skill in the art would understand that similar methods could be used to relieve stress on the film 100 when the film 100 is applied to other curved surfaces.

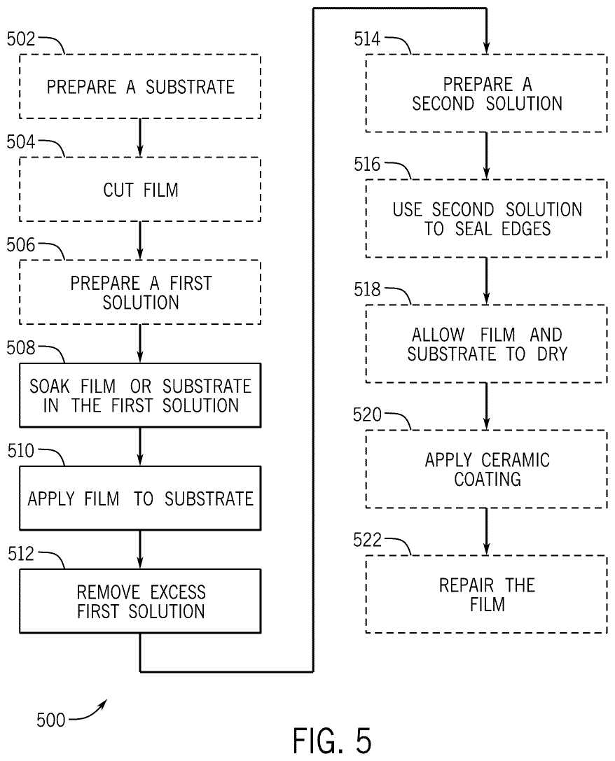

FIG. 5 represents a method 500 of installing film 100 on a substrate 200. In a non-limiting example, FIG. 5 can represent a method 500 of installing film 100 on a window 302 or 402 of a gondola 300 or 400 or another transparent or clear surface of the gondola 300 or 400. However, a person of ordinary skill in the art would understand that a similar method could be used to install the film 100 on other polycarbonate or acrylic substrates that are at least partially transparent or clear.

The method 500 may, at optional block (e.g., manual operation) 502, include preparing a substrate or window of a gondola. In various cases, the substrate or the window is at least partially transparent or clear and comprises or is formed from a polycarbonate or acrylic material. Preparing the surface of the substrate or window can include, without limitation at least one of removing debris from the surface of the substrate or window, sanding the substrate or window, or buffing the substrate or window, or any other method to make the substrate or window smooth.

In some cases, the method 500 can include cutting the film at optional block 504. The film can be cut to be about a same size and about a same shape as the substrate or window where the film is to be installed. In other cases, the film can be cut to be installed on selected locations of the substrate or window. In yet other cases, the film can be cut into one or more pieces that, when placed together on the substrate, are about a same size and about a same shape as the substrate or window where the film is to be installed. Examples of each of these scenarios are discussed above with respect to FIGS. 3A-3F.

The method 500 can include, at block 506, preparing a first solution. In various cases, preparing the first solution could include mixing one or more ingredients together to create the first solution. For example, the first solution could include one or more of alcohol, resin filtered water, distilled water, or other ingredients configured to make a surface of the film, substrate, or window slippery. In various cases, the first solution could be a slip solution, an install gel, or an alcohol solution configured to make the surface of the film, substrate, or window slippery.

In various cases, once the first solution is prepared, the method 500, at block 508, can include soaking the film or the substrate or window in the first solution. For example, the first solution could be applied to at least a bottom surface of the film comprising the adhesive layer. In other cases, the first solution could be applied to both the bottom surface of the film comprising the adhesive layer and the surface of the substrate or window.

Next, the method 500 can include at block 510 applying or installing the film on the substrate or window. In order to install the film on the substrate or window, a bottom surface of the film comprising the adhesive layer and the slip solution can be attached or coupled to a surface of the substrate or window. By applying the first solution to the bottom surface of the film or the bottom surface of the film and the surface of the substrate or window, the film becomes slippery and is able to be easily maneuvered on the substrate or window. Thus, installers of the film can easily maneuver the film into a proper position and orientation on the substrate such that the film at least partially or fully covers a target location on the substrate or window. In some cases, the film could be installed on both first surface (e.g., an outer surface, front surface, top surface, etc.) of the substrate or window and a second surface (e.g., inner surface, back surface, bottom surface, etc.) of the substrate or window.

Once the film is installed at the target location on the substrate or window, the method 500, at block 512 can include removing excess solution from between the film and the window of the gondola. Removing excess first solution from between the film and the window can include applying and moving a squeegee over an outside of the film applied to the substrate or window. In other words, the film can be pressed into the substrate until the excess first solution is removed or mostly removed from between the film and the substrate or window and the adhesive layer of the film couples or sticks to the substrate or window.

The method 500, at optional block 514, can include preparing or mixing a second solution. The second solution could be an alcohol solution comprising an alcohol such as isopropyl alcohol, or the like, mixed in water, such as resin water, distilled water, or the like. In some cases, the second solution may only comprise an alcohol such as isopropyl alcohol.

After or while removing the excess first solution from between the film and the substrate or window, the method 500, at optional block 516 can include, applying a second solution to at least one of one or more edges of the film or one or more edges of the target location on the window or substrate. By using the second solution at the one or more edges of the film or one or more edges of the target location on the window or substrate, the second solution is configured to quickly evaporate or dry which facilitates the film 100 adhering to the substrate or window with little to no bubbling. In other words, because the second solution dries quickly, the one or more edges of the film can more easily adhere to or seal to the target location on the substrate or window and prevent bubbles from forming at the one or more edges.

The method 500, at optional block 518, can include allowing the film or substrate or window to dry or cure. After the excess first solution is removed, the second solution has evaporated, or the film or substrate is dry or cured, the method 500 can include applying a coating to a top surface of the film (block 520). The coating could be a ceramic coating.

The method 500, at optional block 522, can further include repairing the film. In some cases, the film can have one or more tears, divots, bumps, etc. and heat could be applied to the film to repair the film. The heat could be applied to the film using a heat gun, water, steam, or some other heating method.

Thus, embodiments of the inventions provide improved methods and films configured to couple to polyurethane and acrylic materials. In some embodiments, the proposed film and method according to the invention can substantially reduce wear and tear on polyurethane and acrylic surfaces or substrates. In various cases, steps or blocks of the method can occur in a different order than the order mentioned above with respect to FIG. 5 or could include additional steps not disclosed.

In some implementations, devices or systems disclosed herein can be utilized or installed using methods embodying aspects of the invention. Correspondingly, description herein of particular features or capabilities of a device or system is generally intended to inherently include disclosure of a method of using such features for intended purposes and of implementing such capabilities. Similarly, express discussion of any method of using a particular device or system, unless otherwise indicated or limited, is intended to inherently include disclosure, as embodiments of the invention, of the utilized features and implemented capabilities of such device or system.

As used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “exactly one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

We claim:

1. A method for installing a film on a window of a gondola, the method comprising:
soaking the film in a first solution;
applying the film to the window of the gondola, wherein the film and the window of the gondola are at least partially transparent and the window comprises at least one of a polycarbonate material or an acrylic material; and
removing excess first solution from between the film and the window of the gondola.

2. The method of claim 1 further comprising:
before soaking the film in the first solution, preparing a surface of the window, wherein preparing the surface of the window comprises at least one of removing debris from the surface of the window, sanding the window, or buffing the window.

3. The method of claim 1 further comprising:
before soaking the film in the first solution, preparing the first solution by mixing alcohol in resin filtered water.

4. The method of claim 1, wherein soaking the film in the first solution comprises applying the first solution to both a first side and a second side of the film, the method further comprising soaking the window in the first solution.

5. The method of claim 1, wherein soaking the film in the first solution comprises applying the first solution to a first side of the film, wherein the first side of the film includes an adhesive.

6. The method of claim 1, wherein removing excess first solution from between the film and the window comprises applying and moving a squeegee over an outside of the film applied to the window.

7. The method of claim 1, after or while removing the excess first solution from between the film and the window, applying a second solution to at least one of one or more edges of the film or one or more edges of the window.

8. The method of claim 7, wherein the second solution comprises alcohol.

9. The method of claim 1, after removing the excess first solution from between the film and the window, the method comprises:
allowing the film and the window to dry; and
once the film and the window are dry, applying a coating to an outer surface of the film.

10. The method of claim 9, wherein the coating is a ceramic coating.

11. The method of claim 1 further comprising:
applying the film to a curved surface of the window, wherein applying the film to a curved surface of the window comprises shaping the film to be substantially a same shape and substantially a same size as the curved surface of the window, cutting the film into two or more pieces, and applying each piece of the film to the curved surface of the window.

12. The method of claim 11, wherein the curved surface of the window is shaped like a half circle, and wherein the film is cut into at least three pieces.

13. The method of claim 1, wherein the film comprises one or more tears, the method further comprising:
repairing the one or more tears of the film by applying heat to a location of the film surrounding the one or more tears.

14. The method of claim 1, wherein the film is applied to an outer surface of the window and an inner surface of the window opposite the outer surface of the window.

15. The method of claim 1, wherein the film comprises a top coat layer, a thermoplastic polyurethane layer, and an adhesive layer.

16. A method for installing a film on a substrate, the method comprising:
soaking the film in a first solution;
applying the film to the substrate, wherein the film and the substrate are at least partially transparent and wherein the substrate comprises at least one of a polycarbonate material or an acrylic material;
removing excess solution from between the film and the substrate; and
while or after removing excess solution from between the film and the substrate, applying a second solution to one or more edges of the film to seal the one or more edges of the film to the substrate.

17. The method of claim 16 further comprising:
applying the film to a curved surface of the substrate, wherein applying the film to the curved surface of the substrate comprises shaping the film to be substantially a same shape and substantially a same size as the curved surface of the substrate, cutting the film into two or more pieces, and applying each piece of the film to the curved surface of the substrate.

18. The method of claim 17, wherein the curved surface of the substrate is shaped like a half circle, and wherein the film is cut into at least three pieces.

19. The method of claim 17, wherein applying the film to the substrate comprises applying the film to an inner surface and an outer surface of the substrate opposite the inner surface of the substrate.

20. A method for installing a film on a window of a gondola, the method comprising:
preparing a surface of the window of the gondola;
soaking the film in a first solution;
soaking the window in the first solution;
applying the film to the window of the gondola, wherein the film and the window of the gondola are at least partially transparent and wherein the window comprises at least one of a polycarbonate material or an acrylic material;
removing excess first solution from between the film and the window of the gondola;
while or after removing the excess first solution from between the film and the window of the gondola, applying a second solution to one or more edges of the film to seal the one or more edges of the film to the window;
allowing the film and window of the gondola to dry; and
after the film and the window of the gondola are dry, applying a ceramic coating to an outer surface of the film.
